(19) United States
(12) Patent Application Publication
(10) Pub. No.: US 2024/0196922 A1
(43) Pub. Date: Jun. 20, 2024

(54) FOOD PRODUCT

(71) Applicant: Mars, Incorporated, McLean, VA (US)

(72) Inventors: Hans VAN HOUTUM, Chicago, IL (US); Robin LAARMAN, Chicago, IL (US); Stephan MEULENSTEEN, Chicago, IL (US)

(73) Assignee: Mars, Incorporated, McLean, VA (US)

(21) Appl. No.: 18/554,897

(22) PCT Filed: Apr. 15, 2022
(86) PCT No.: PCT/US2022/025120

§ 371 Date: Oct. 11, 2023

(30) Foreign Application Priority Data
Apr. 16, 2021 (GB) 2105467.1

(51) Int. Cl. A23G 3/48; A23G 1/48; A23G 1/54; A23G 3/44; A23G 3/54

(52) U.S. Cl. CPC A23G 3/48; A23G 1/48; A23G 1/54; A23G 3/44; A23G 3/54

(57) ABSTRACT

The invention relates to a plant-based nougat comprising potato protein isolate, a sugar syrup and a flavouring component, and a method of making the nougat. A confectionery product comprising the nougat and a component selected from plant-based caramel and plant-based chocolate is also disclosed, together with a method for making the nougat.

### FIELD OF THE INVENTION

The present invention relates to a plant based nougat and a food product, which may be termed a confection, comprising the plant based nougat. Methods for making the plant-based nougat and the food product are also provided.

### BACKGROUND OF THE INVENTION

Plant-based food products are becoming increasingly desirable to consumers. This is due to consumer concerns relating to animal welfare, the environmental impact of animal farming, and health risks associated with animal products. Plant-based food products include vegan food products. It is typically difficult to reformulate an existing food product which contains ingredients derived from animals into a plant based or vegan product while still providing a food product which is enjoyed by consumers.

Confectionery products such as chocolate are popular food products. The traditional ingredients for chocolate are derived from the cocoa bean. As such, chocolate can be prepared as a plant-based product. However, many chocolate products contain ingredients derived from animals and are not plant-based. Products labelled “milk chocolate” usually contain milk. Products labelled “dark chocolate” may also contain milk in lower quantities. Chocolate products may contain other ingredients derived from animals, e.g. whey, casein, and certain emulsifiers.

Dairy products such as milk chocolate or confectionery products containing animal derived ingredients such as milk, egg and dairy protein can be problematic for those with allergies or food intolerances, or those who adhere to dairy-free or vegan diets. There is an increasing need to provide a vegan or dairy-free chocolate or confectionery product that has the same taste and pleasing mouthfeel as standard milk chocolate or confectionery products containing dairy ingredients or animal-based ingredients. There is, therefore, a continuing need in the confectionery field to match consumer expectations in terms of an organoleptically desirable vegan or plant-based confectionery.

Accordingly, there a desire for a plant-based confectionery chocolate product that possesses the taste, texture and feel of a standard milk chocolate confection, is economical to produce, and has favourable processability and rheological properties. “Vegan milk chocolates” are well known and have been prepared in the prior art, using coconut milk, rice milk, or almond milk.

In particular, there is a need, however, to provide multi-textured plant based confectionery items such as composite chocolate bars which typically comprise components made up of nougat, caramel and/or nuts. These type of confections provide particular challenges as such products can be difficult to manufacture. There is a need for further plant-based food products.

Nougat is a popular confectionery item. Nougat is typically not a plant-based product. Nougat may be available as a discrete product in itself. Alternatively, it is present as a component of composite confectionery items such as bars which comprise other elements such as chocolate, as well as caramels including aerated caramels, toffees, fudges, nuts, wafers, biscuits, gels, flavoured creams or pralines. Nougats traditionally comprise sugars which may be in the form of honey as well as egg white, which provides a source of protein. Some nougats are hard and chewy but softer nougats, sometimes called nougatines, contain higher moisture content. They may contain ingredients such as cocoa, milk powder, lactose, malt and icing sugar, which have a shortening effect. Fat and emulsifiers may also be included. Typical nougat recipes are described for example in ‘Sugar Confectionery Manufacture’ (Berlin:Springer) Second edition, 1995 Ed. E. B. Jackson and in particular in Table 13.3 which shows some specific examples.

As described in US2017/245519A1, nougat is typically prepared by mixing together appropriate amounts of a sugar syrup and a protein mixture, aerating the mixture and thereafter mixing the resultant frappe with a suitable quantity of flavoring/graining mixture. Typically, frappe is prepared using a syrup solution prepared by mixing a sugar such as granulated sucrose with sufficient water to form a solution, which sugar solution is formed into a ‘base syrup’ or ‘doctor syrup’ by addition of glucose and optionally other ingredients such as salt.

It is then generally necessary to subject the base syrup to a heating or cooking procedure to remove at least some of the water before the syrup is of an appropriate concentration to go forward to the subsequent processing stages. Highly elevated temperatures for example of up to 140° C. are generally required in order to evaporate water so as to reduce the water content in line with the recipe. On cooling, the resultant syrup forms a highly saturated solution which changes state during production to a crystalline form to obtain the desired texture properties. Residual energy may be used subsequently to assist in coagulating protein. Notably, the protein is typically derived from animals, such as powdered egg and/or milk protein. The egg and/or milk protein is typically considered to be necessary to create a stable aerated sugar network.

Caramel is another popular confectionery product. Caramels, toffees and fudges are particularly popular confectionery items. They may be available as a discrete product in itself. Alternatively, they may be present as a component of composite confectionery items such as bars which comprise other elements such as chocolate, as well as nougats, nuts, wafers, biscuits, gels, flavoured creams or praline. Caramels are characterised as high sugar containing confections. A substantial proportion of the sugar may be provided by glucose syrup, but caramels typically also contain fats, milk, flavourings and water.

The amount of water present in any particular caramel, toffee or fudge, will impact on its taste and texture, but also, of its processability. And, while some caramel, toffee or fudge confections are desirably more fluid, e.g., ice cream toppings or certain filled confections, in other applications, these confections may desirably be chewy in texture. Such confectionery items will contain less water. While the former can be messy to consume, but easy to deposit, the latter provides a cleaner consuming experience, but can be difficult to handle during manufacture.

Nougat and caramel are typically not plant-based food products because they contain ingredients such as dairy protein and/or egg protein. For example, typical nougats comprise an aerated sugar network which is stabilised by dairy and/or egg protein. Typical caramels comprise dairy products such as milk. There is a need for plant-based alternatives to nougat and caramel.

WO 2018/167788 A1 discloses non-dairy and/or vegan confectionery products, especially chocolate-based products, and methods of their preparation. WO 2011/072834 A1 discloses a chocolate composition comprising cocoa butter, sugar, and coconut milk. EP 3369324 A1 discloses a formulation of a mixture especially designed for producing milk-free (milk protein-free and lactose-free), sugar-free and soy-free white chocolate with or without fibres in its composition. EP 3338559 A1 discloses a chocolate formulation with carob, with low caffeine and theobromine contents, animal milk-free, with or without added sugars, gluten-free, soy-free, with or without fiber, using cocoa and carob as the basis, alternatively supplemented with coconut fat, rice derivatives, powdered sweet potato and sugars having a low glycemic index.

TW 201032726 A discloses a nougat composition comprising: 32-41 wt % maltose, 17-22 wt % sugar, 6-8 wt % fat/oil, 6-10 wt % mixed cereal powder, 20-30 wt % nuts material, 3-6 wt % water, and 0.01 5 wt % protein material.

The following disclosure is presented to provide an illustration of the general principles of the present invention and is not meant to limit, in any way, the inventive concepts contained herein. Moreover, the features described in this section can be used in combination with the other described features in each of the multitude of possible permutations and combinations contained herein.

### BRIEF DESCRIPTION OF THE DRAWINGS

Additional features and advantages of the present invention are described in, and will be apparent from, the description of the presently preferred embodiments which are set out below with reference to the drawings in which:

FIG. 1 is a photograph of three plant-based confectionery products according embodiments of the present invention.

### DETAILED DESCRIPTION OF THE PREFERRED EMBODIMENTS

The present specification provides certain definitions and methods to better define the present invention and to guide a person skilled in the art in the practice of the present invention. Provision, or lack of the provision, of a definition for a particular term or phrase is not meant to imply any particular importance, or lack thereof. Rather, and unless otherwise noted, terms are to be understood according to conventional usage by those persons skilled in the relevant art.

The term “plant-based” refers to a product which is formulated without ingredients derived from animals. A plant-based product may contain traces of ingredients derived from animals, such as traces of dairy ingredients. For example, traces of dairy ingredients may be present in plant-based products due to use of manufacturing lines which have previously been used to make dairy-based products. The term “plant-based” may refer to a product which comprises less than 1 wt %, preferably less than 0.1 wt % ingredients derived from animals.

The term “plant-based” encompasses the term “vegan”. The term “vegan” refers to a product which is formulated without ingredients derived from animals or insects. The term “vegan” may refer to a product which comprises less than 1 wt %, preferably less than 0.1 wt % ingredients derived from animals or insects. The plant-based products and processes of the invention are preferably vegan products and processes.

The term “potato” encompasses the tuber of the plant Solanum tuberosum.

As used herein, “potato protein” refers to any protein isolated from potato. Potato protein and potato protein isolate are used interchangeably herein. Potato protein typically includes the protein tuberine, and this can be present in potato protein in an amount of at least 50 wt %. Tuberine can be fractionated into albumin and globulin. The potato protein may comprise proteins selected from albumin, globulin, prolamine and glutelin. Potato protein may comprise at least 40 wt % albumin, at least 20 wt % globulin, and least 1 wt % prolamine, at least 5 wt % glutelin, with the balance of the potato protein being other proteins extracted from potato.

Aspects of the disclosure relate to a shelf stable plant based protein aerated nougat, an aerated confectionary product, manufacturing and/or batch processing operations for making a food product including the plant based aerated nougat. The aerated nougat can include mechanically denaturated proteins and/or fibers without significantly effecting texture and or taste of the finished product. Further, manufacturing and or batch processing operations for making the aerated nougat can be simplified into a single step batch process.

### Plant-Based Nougat

Herein is provided a plant-based nougat comprising potato protein isolate, a sugar syrup and a flavouring component.

This invention may make use of either a native potato protein mixture, which can be added in form of a general potato protein isolate or it makes use of a patatin isolate or protease inhibitor isolate. The present inventors have found that potato proteins are particularly effective in the production process in that the aerated products are particularly stable compared to equivalent products produced with other plant proteins, and can produce nougat that is comparable in taste, texture and appearance to nougat produced with animal proteins, such as egg or milk proteins. Potato proteins can be classified in a number of ways. In one classification, the potato protein can be classified depending on whether it is acid soluble or acid coagulable. Acid soluble proteins are those that solubilise in water at a pH of 3 to 5, while acid coaguable proteins are those that are insoluble in water at a pH of from 3 to 5 (since they have coagulated). The acid soluble potato proteins can be fractionated, i.e. isolated from or separated from, the acid coaguable potato proteins. Acid soluble proteins tend to have a higher molecular weight than the acid soluble proteins. The acid soluble proteins have been found to have a molecular weight in the range of 32 to 87 kDa, as measured by SDS-PAGE analysis. The acid coagulable potato proteins have been found to have a molecular weight of from 17 to 28 kDa, as measured by SDS-PAGE analysis. The potato protein isolate may comprise a potato protein that has been isolated and fractionated on the basis of molecular weight, e.g. potato protein isolate that has been fractionated into an isolate containing predominantly proteins that are acid soluble or those that are acid coagulable.

In an embodiment, at least 50 wt %, optionally at least 75 wt %, optionally at least 90 wt %, optionally at least 95 wt %, of the potato protein isolate contain potato proteins having a molecular weight of 30 kDa or more, as measure by SDS-PAGE analysis. Potato protein having such a molecular weight are commercially available, e.g. Solanic 200, available from Avebe Such potato protein comprises patatin, which is a family of glycoproteins. Nougat produced with this type of potato protein was found to have a slighter darker colour compared to that of lower molecular weight protein, and a slightly more of a potato taste. Its texture was comparable with that of the nougat made in the traditional way with egg or milk protein.

In an embodiment, at least 50 wt %, optionally at least 75 wt %, optionally at least 90 wt %, optionally at least 95 wt %, of the potato protein isolate contain potato proteins having a molecular weight of less than 30 kDa, as measure by SDS-PAGE analysis. Potato proteins having such a molecular weight are commercially available, e.g. Solanic 300, available from Avebe. Such potato protein comprises protease inhibitors. Methods of obtaining such a potato protein have been published, e.g. in WO2008/069650. Nougat produced with this type of potato protein was found to have the same colour and substantially the same texture and taste as nougat made in the traditional way with egg or milk protein. It seemed to require less whipping time than nougat made with higher molecular weight potato protein.

Also fractions or derivatives of the above can be used.
These proteins or fractions thereof, mentioned above, are preferably dosed in a form of dry potato protein powder with a moisture content 5 wt. %-10 wt. %.
The quantity of native potato protein present in the nougat may be from 0.5 to 15 wt % or the nougat, optionally 0.5-10 wt. % of the nougat, optionally 0.5-8.0 wt. % of the nougat.

The plant-based nougat may comprise or be formed from 65-95 wt %, preferably 70-90 wt %, most preferably 75-85 wt % sugar syrup. The sugar syrup may be selected from sucrose syrup, glucose syrup, invert syrup, honey, and mixtures thereof. The sugar syrup may comprise water. For example, the sugar syrup may comprise 1-15 wt % water and 99-85 wt % sugars, preferably 5-10 wt % water and 95-90 wt % sugars. The nougat may comprise or be formed from at least 50 wt % sugar syrup, optionally at least 60 wt % sugar syrup, optionally at least 65 wt % sugar syrup, optionally at least 70 wt % sugar syrup. The plant-based nougat may comprise 41-72 wt % sugar, preferably 56-76 wt % sugar, most preferably 60-68 wt % sugar (sugar in this context being the dry sugar). The sugar may be selected from sucrose, glucose, sugar from invert syrup, sugar from honey, and mixtures thereof.

The flavouring component may be selected from cocoa, e.g. cocoa powder, honey, and a nut-derived component. The nut-derived component may comprise components derived from nuts selected from almonds, brazils, cashews, chestnuts, hazelnuts, macadamias, peanuts, pecans, pistachios, and walnuts. The nut-derived component may be selected from a nut butter and chopped nuts. The nut butter advantageously helps to stabilise the plant-based nougat. The plant-based nougat may comprise 1-20 wt %, preferably 3-15 wt %, most preferably 5-10 wt % nut butter. A nut butter is a spreadable foodstuff which is made by grinding nuts into a paste. The nut butter may be selected from butters made from almonds, brazils, cashews, chestnuts, hazelnuts, macadamias, peanuts, pecans, pistachios, and walnuts. Most preferably, the nut butter is peanut butter. The nut butter may be a smooth nut butter.

The plant-based nougat may further comprise nut inclusions as the flavouring component. The plant-based nougat may comprise 1-20 wt %, preferably 3-15 wt %, most preferably 5-10 wt % nut inclusions. The nut inclusions may be selected from almonds, brazils, cashews, chestnuts, hazelnuts, macadamias, peanuts, pecans, pistachios, and walnuts. Most preferably, the nut inclusions are peanuts. The nut inclusions may be in the form of chopped nuts, for example chopped nuts of about 2-4 mm in size.

The nougat may comprise from 0.5 to 20 wt % flavouring component, optionally from 0.5 to 15 wt % flavouring component, optionally 0.5 to 12 wt % flavouring component.

The density of the plant-based nougat may be 600-1100 kg/m3, preferably 800-1000 kg/m3, most preferably about 890 kg/m3.

A nougat typically lacks gelatin and/or a gelling starch, e.g. the plant-based nougat may contain less than 5 wt % gelatin and/or a gelling starch, optionally less than 2 wt % gelatin and/or a gelling starch, optionally less than 1 wt % gelatin and/or a gelling starch, optionally less than 0.5 wt % gelatin and/or gelling starch, optionally no gelatin and/or gelling starch.

Advantageously, the plant-based nougat provides sensory properties that are acceptable in comparison to typical non-plant-based nougats.

The nougat may or may not be combined with the plant-based caramel and/or the plant-based chocolate. The nougat may be formed into a food product, e.g. a bar comprising or consisting of the nougat, without the plant-based caramel or the plant-based chocolate. In some embodiments, the nougat may be combined with one or more confectionary fillings as the flavouring component, which may be incorporated into or disposed onto the nougat. The one or more confectionary fillings be selected from fudge, candy floss (also known as cotton candy), ganache, meringue, marzipan, hard boiled candy, toffees, butterscotch, nut brittles or croquant, pralines or caramels, truffles, fourres, nut pastes, nut butters including peanut butter, coconut paste, creme paste, licorice paste, chocolate spreads, chocolate crumb, taffy, creme, mousse, nut butter, nut creme, fruit fillings, fondant including fondant-based cremes, frappe, fruit juice; vegetable juice; fruit puree; fruit pulp; vegetable pulp; vegetable puree; fruit sauce; vegetable sauce; honey; maple syrup; molasses; corn syrup; sugar syrup; liqueurs; chocolate syrup, dairy-based liquids such as milk, cream, or a combination of any number of these, or plant-based versions thereof.

### Process for Making Plant-Based Nougat

Herein is provided a method of producing a plant-based nougat, the method comprising aerating a whip solution comprising potato protein isolate, wherein a sugar syrup is added to the whip solution before, during or after aerating the whip solution, to form a frappe, and adding a flavouring component to the frappe to form the plant-based nougat. In alternative embodiments, the flavouring component is added to the whip solution before aeration to form the frappe, and the frappe then is a nougat.

The plant-based nougat may be made by a process comprising the steps of:
providing a whip solution comprising potato protein;
aerating the whip solution;
adding a heated sugar syrup to the whip solution;
whipping the whip solution comprising the added sugar syrup to form a frappe; and
incorporating the flavouring component, e.g. folding a nut butter, into the frappe.

The sugar syrup may be added to the whip solution before the whip solution is aerated. Preferably, the sugar syrup is added to the whip solution after the whip solution is aerated.

That is, preferably the process for making plant-based nougat comprises the steps of:
providing a whip solution comprising potato protein;
aerating the whip solution to provide an aerated whip solution;
adding heated sugar syrup to the aerated whip solution;
whipping the aerated whip solution comprising the added sugar syrup to form a frappe; and
incorporating the flavouring component, e.g. folding a nut butter, into the frappe.

The term “frappe” refers to an aerated or foamed mixture comprising sugars and proteins which is stabilised by the proteins.

The potato protein, sugar syrup, and flavouring component are as described above in connection with the plant-based nougat. Providing the whip solution may comprise adding potato protein in dry powder form to water. Alternatively, Providing the whip solution may comprise adding potato protein in the form of a solution or suspension of the potato protein in a liquid, such as water, to water or a further amount of water, which may be in a sugar syrup.

The whip solution may form 0.5-20 wt %, preferably 1-15 wt %, most preferably 2-10 wt % of the ingredients used to make the plant-based nougat. The sugar syrup may form 65-95 wt %, preferably 70-90 wt %, most preferably 75-85 wt % of the ingredients used to make the plant-based nougat. The flavouring component form 1-20 wt %, preferably 3-15 wt %, most preferably 5-10 wt % of the ingredients used to make the plant-based nougat.

The process may comprise folding nut inclusions into the frappe, preferably at the same time as another flavouring component such as the nut butter and/or cocoa, is folded into the frappe. The nut inclusions may form 1-20 wt %, preferably 3-15 wt %, most preferably 5-10 wt % of the ingredients used to make the plant-based nougat. The nut inclusions are as described above in connection with the plant-based nougat.

The sugar syrup may be heated to 110-150° C., preferably 115-145° C., most preferably 120-140° C.

Suitable aeration techniques include dispersing air into the mixture under pressure, or utilising a pressure beater aerate the mixture. Aeration may also be achieved by whisking. Aeration may be effected in a pressurised system using a pressure beater. Such devices generally comprise a stator and rotor, which may be provided with pins, forming a ‘pin beater’. In this arrangement, the mixture is mixed in a container into which pressurized air is fed. The pressure of air applied will depend upon factors such as the consistency of the medium (comprising sugars and protein) to be aerated, and the parameters of the pressurized system, for example, the degree of back pressure delivered into the pressure device by a downstream pressure valve, but will typically be in the range of from 3-5 bar. Suitable mixing speeds will be in the range of 300-1200 rpm. The temperature at which the aeration is carried out is selected so as to ensure that the viscosity of the mixture is suitable to allow it to be beaten and for air bubbles to be entrapped and dispersed within it and hold the air bubbles within it. It may be in the range of from 25-110° C., or 30-90° C., or 35-65° C., although at the higher levels, proteins may coagulate. If this is not required, then the temperatures may be kept below 65° C. Whipping refers to high intensity stirring. Whipping may also cause aeration.

### Plant-Based Food Product

Herein is provided a plant-based food product comprising
the plant-based nougat described herein;
a component selected from plant-based chocolate and plant-based caramel.

The plant-based food product may comprise, consist essentially of or consist of:
the plant-based nougat described herein; and
plant-based chocolate.

The plant-based food product may comprise 15-55 wt %, preferably 25-45 wt %, most preferably 30-40 wt % plant-based chocolate, with at least 90 wt %, optionally 100 wt %, of the remaining plant-based food product being the plant-based nougat.

The plant-based food product may comprise 15-55 wt %, preferably 25-45 wt %, most preferably 30-40 wt % plant-based caramel, with at least 90 wt %, optionally 100 wt %, of the remaining plant-based food product being the plant-based nougat.

The plant-based food product may comprise a layer comprising the nougat and a further layer comprising the plant-based chocolate. The plant-based chocolate may partly or completely cover the plant-based nougat. The plant-based nougat may form a layer and the plant-based chocolate may cover one or more sides of, optionally all sides of, the layer of plant-based nougat. The plant-based food product may comprise a layer comprising the nougat and a further layer comprising the plant-based caramel. The plant-based caramel may partly or completely cover the plant-based nougat. The plant-based nougat may form a layer and the plant-based caramel may cover one or more sides of, optionally all sides of, the layer of plant-based nougat. The plant-based food product may be in the form of a bar.

The plant-based food product may comprise, consist essentially of or consist of:
the plant-based nougat described herein;
plant-based caramel and
plant-based chocolate.

The plant-based food product may comprise a plant-based food product comprising:
1-65 wt %, preferably 1-40 wt %, preferably 10-30 wt %, most preferably 15-25 wt % plant-based nougat, wherein the plant-based nougat comprises plant-based protein, sugar syrup, and nut butter;
25-65 wt %, preferably 35-55 wt %, most preferably 40-50 wt % plant-based caramel, wherein the plant-based caramel comprises a plant-based milk, plant-based fat, and sugar syrup; and
15-55 wt %, preferably 25-45 wt %, most preferably 30-40 wt % plant-based chocolate.

The plant-based food product may comprise a first layer comprising the nougat, a second layer comprising the plant-based caramel and a third layer comprising the plant-based chocolate. The plant-based chocolate may partly or completely cover the plant-based nougat and the plant-based caramel. The plant-based food product may comprise a layer of plant-based nougat and a layer of plant-based caramel disposed on a side of the plant-based nougat, and the plant-based chocolate may cover one or more sides of, optionally all sides of, the layers of plant-based nougat and plant-based caramel. The plant-based food product may comprise a single layer of plant-based nougat and a single layer of plant-based caramel disposed on a side of the plant-based nougat, and the plant-based chocolate may cover one or more sides of, optionally all sides of, the layers of plant-based nougat and plant-based caramel, to form a plant-based chocolate-covered bar. The plant-based food product may be in the form of a bar.

The plant-based food product may have a weight typical for a confectionery product. For example, the weight may be 1 to 70, for example 5 to 70 g, 5 to 60 g, optionally 20 to 60 g, optionally 30 to 60 g, optionally 40 to 60 g, optionally 20 to 40 g, optionally 1 to 20 g, optionally 1 to 10 g. The weight may preferably be about 29.5 g. The plant-based food product may be a confectionery product. The product may have dimensions typical for a confectionery product. The plant-based food product may be in the form of a bite size product or a bar. The bar may have a length of 30-70 mm, preferably 35-65 mm, most preferably 40-60 mm; a width of 10-50 mm, preferably 15-45 mm, most preferably 20-40 mm; and a height of 5-35 mm, preferably 10-30, most preferably 12-25 mm. The height of the plant-based nougat may be 4-30 mm, for example 4-20 mm, for example 4-10 mm, preferably 4-8 mm, preferably about 6 mm along the length (longest dimension) of the plant-based food product. The height of the plant-based caramel may be 8-12 mm, preferably about 9.5 mm along the length (longest dimension) of the plant-based food product.

Herein is provided a method of producing a plant-based food product, the method comprising combining a plant-based nougat described herein, and a component selected from a plant-based caramel and a plant-based chocolate to form the plant-based food product.

In an embodiment, the plant-based nougat is produced, preferably in the form of a layer, and then one or more of the other components of the plant-based food product are coated onto the nougat. In an embodiment, the plant-based nougat is produced, preferably in the form of a layer, and then the plant-based chocolate is coated on one or more sides of the plant-based nougat, optionally all sides of the plant-based nougat to completely envelope the nougat in the plant-based chocolate.

In an embodiment, the plant-based nougat is produced, preferably in the form of a layer, and then a layer of plant-based caramel is disposed on the plant-based nougat, to form an intermediate bar, and then the plant-based chocolate is coated onto one or more sides of, preferably all sides of, the intermediate bar, to completely enveloped the plant-based caramel and plant-based nougat. In an embodiment, the plant-based nougat is produced, preferably in the form of a layer, and then the plant-based chocolate is coated on one or more sides of the plant-based nougat, optionally all sides of the plant-based nougat to completely envelope the nougat in the plant-based chocolate.

### Plant-Based Caramel

The plant-based caramel comprises a plant-based milk, plant-based fat, and sugar syrup.

The sugar syrup may be selected from sucrose, glucose, invert syrup, honey, and mixtures thereof. The sugar syrup may comprise water.

The plant-based milk may be selected from coconut milk, almond milk, soy milk, rice milk, cashew milk, hemp milk, oat milk, flax milk, hazelnut milk, pea milk, and mixtures thereof. Preferably the plant-based milk is selected from coconut milk and/or soy milk.

The plant-based fat may be selected from palm oil, cocoa butter, and sunflower oil. It will be understood that the plant-based fat is in addition to fat present in the plant-based milk.

The plant-based caramel may comprise a humectant. The humectant may be a polyol. The humectant may be selected from sorbitol, glycerol, hydrogenated starch hydrolysates, hydrogenated isomaltose, maltitol, mannitol, xylitol, erythritol, and mixtures thereof. The humectant is preferably glycerol. The plant-based caramel may comprise 0.5-60 wt %, 2-30 wt %, preferably 5-25 wt %, most preferably 10-20 wt % of the humectant.

The density of the plant-based caramel may be 800-1400 kg/m³, preferably about 1160 kg/m³ most preferably 400-1400 kg/m³.

The plant-based caramel may further comprise inclusions. The plant-based caramel preferably further comprises nuts. The plant-based caramel may comprise 25-55 wt % nuts, preferably 30-50 wt % nuts, most preferably 35-45 wt % nuts. When present, the nuts in the plant-based caramel are most preferably peanuts.

Advantageously, the plant-based caramel provides sensory properties that are equivalent to typical non-plant-based caramels.

### Process for Making Plant-Based Caramel

The plant-based caramel may be made by a process comprising the steps of:
providing a batch milk comprising plant-based milk and plant-based fat; and
adding a heated sugar syrup to the batch milk to form a caramel.

The plant-based milk, plant-based fat, and sugar syrup are as described above in connection with the plant-based caramel. The process may further include mixing inclusions into the caramel.

The sugar syrup may be heated to 115-145° C., preferably 120-140° C., most preferably 125-135° C. The sugar syrup may form 25-55 wt %, preferably 30-50 wt %, most preferably 35-45 wt % of the ingredients used to make the plant-based caramel.

The batch milk may be heated before the sugar syrup is added, preferably to 30-80° C., most preferably to 40-70° C. The process may include a further step of heating the caramel to evaporate moisture and form a browned caramel, preferably at a temperature of 100-150° C., most preferably 120-145° C. Advantageously, the browned caramel has an improved flavour.

The process may include a further step of adding a humectant to the caramel. Preferably, the humectant is added to the browned caramel. The humectant may form 1-20 wt %, or 3-15 wt %, or 7 12 wt % of the ingredients used to make the plant-based caramel. Advantageously, the humectant improves the rheological properties of the plant-based caramel, making it more suitable for use in downstream processes. The humectant is as described above.

The batch milk may comprise further ingredients selected from sugars such as glucose, flavourings such as vanilla extract, salt, and mixtures thereof. For example, the batch milk may comprise sugars such as glucose forming 1-20 wt % or 5-15 wt % of the ingredients used to make the plant-based caramel.

The plant-based milk may form 15-55 wt %, preferably 25-45, most preferably 30-40 wt % of the ingredients used to make the plant-based caramel. The plant-based fat may form 1-20 wt %, preferably 3-15 wt %, most preferably 5-10 wt % of the ingredients used to make the plant-based caramel. It will be understood that these amounts do not include plant-based fat present in the other ingredients of the caramel, e.g. the plant-based milk.

The plant-based caramel may have a moisture content ranging from 0.1 wt % to 16 wt %, preferably from 0.5 wt % to 14 wt %, even more preferably from 1.0 wt % to 12 wt %, most preferably 1.0 wt % to 5 wt %.

The plant-based caramel of the present invention may have a density of 100-8000 kg/m³, preferably 500-5000 kg/m³, more preferably 600-3000 kg/m³, more preferably 800-1500 kg/m³.

The process for making plant-based caramel may include mixing the ingredients in a heating vessel; heating the ingredients to form a uniform heated mixture while scraping the vessel during heating to prevent scorching; and increasing the heat to boil the ingredients to a temperature and for a time to achieve a desired level of caramelisation.

### Plant-Based Chocolate

Plant-based chocolates are readily available from a number of commercial suppliers. The plant-based chocolate may be a compound chocolate. The plant-based chocolate is preferably a plant-based “milk chocolate”. Plant-based “milk chocolates” may comprise sugar, cocoa butter, cocoa solids, and a plant-based milk. It has been found that a plant-based “milk chocolate” or couverture chocolate comprising rice milk provides a good flavour profile in combination with the other components of the plant-based food product.

### EXAMPLES

A plant-based nougat was prepared from the following ingredients:

### (i) Base Syrup

Glucose 40 wt %
Sugar 40 wt %
Water 18 wt %
Salt 2 wt %
Total 100%

### (ii) Whip Solution

Base syrup 72 wt %
Water 23 wt %
Potato protein 5 wt %
Total 100%

The nougat comprised the whip solution mentioned above (in 86 wt %) and peanut butter (7 wt %) and chopped peanuts (7 wt %)

The whip solution comprising potato protein was aerated, the sugar syrup was cooked to 140° C. and added to the aerated whip solution and the result was whipped into a frappe. The peanut butter and chopped peanuts were added to the frappe.

A plant-based coconut caramel was prepared from the following ingredients:

### Sugar Syrup (38 wt %):

27 wt % granulated sugar
11 wt % water

### Batch Milk (52 wt %):

34 wt % coconut milk (17% fat)
11.5 wt % glucose
0.5 wt % salt and vanilla extract
6 wt % sunflower oil

### Glycerol (10 wt %)

The batch milk was warmed to 55° C. The syrup was cooked to 130° C. and added to the batch milk. The resulting caramel was cooked at 140° C. The glycerol was then mixed in.

Peanuts may subsequently be mixed into the caramel.

A plant-based soy caramel was prepared from the following ingredients:

### Sugar Syrup (42 wt %):

19 wt % brown sugar and granulated sugar
13 wt % water

### Batch Milk (58 wt %)

38 wt % soy milk
12.5 wt % glucose
0.5 wt % salt and vanilla extract
7 wt % sunflower oil

The batch milk was heated to 55° C. The syrup was cooked to 130° C. and added to the batch milk. The resulting caramel was cooked at 123° C. Peanuts may subsequently be mixed into the caramel.

A plant-based food product was made from the plant-based nougat, the coconut caramel, and a commercially-available plant-based milk chocolate. The product contained 21 wt % of the nougat, 44 wt % of the caramel (which contained 38 wt % peanuts and 62 wt % coconut caramel), and 35 wt % of the chocolate.

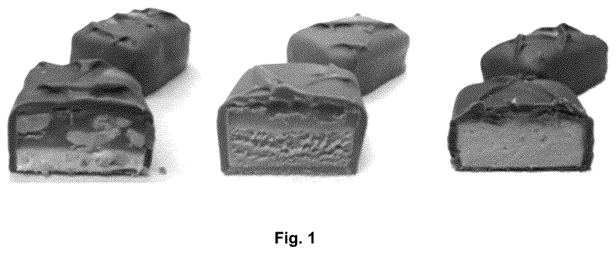

The product was in the form of a bar having a layer of the nougat and a layer of the caramel, encased in the chocolate. A taste panel found the product to be an enjoyable confectionery product, notwithstanding that it was a plant-based food product. The left-hand bar in FIG. 1 illustrates such a bar when cut along its length to reveal a lower layer of nougat, on which sits a caramel layer, both of which are encased in chocolate. Both the caramel layer and the nougat layer can be seen to contain chopped nut inclusions. The middle bar is similar to the left-hand bar in construction, except that no chopped nut inclusions are included in the nougat or the caramel. The right-hand bar illustrates a bar having a layer of nougat, without nut inclusions, encased in chocolate.

In a further Example, the plant-based nougat may be made as follows. In this Example, the formulation of a nougat suitable for use may include 0.37% w/w potato protein, 3.13% w/w water, 6.59% w/w sugar, 2.00% w/w water, 36.63% w/w sugar 36.63% w/w glucose syrup and 14.65% w/w water. The nougat may be prepared by dissolving the potato protein in the 3.13 wt. % water while the 6.59% sugar is dissolved in the 2.00% water. The potato protein and sugar solution are then mixed together and aerated. In a separate vessel, the 36.63% sugar is dissolved in the 14.65% water and the glucose syrup is added with mixing.

This sugar solution is then boiled to 141° C. The boiled sugar solution is then added to the whipped potato/sugar solution in a thin stream. The formed product is referred to as nougat frappe, which can be formed into a nougat bar, and/or combined with caramel and chocolate, as described above.

Different elements may be added to this frappe:

The frappe can be mixed with a form of nuts, fruit or seeds or a combination thereof (typically 5% wt.-50% wt.). The frappe can also comprise a “slurry” element. This slurry can contain a flavour (e.g. malt, cocoa, fruit extract) and or a form of crystallization seed (e.g. lactose, icing sugar) and fat as carrier. The frappe can also comprise a level of fat only (e.g. from about 0.5-30 wt. % by weight of the nougat product). The combination of frappe and elements mentioned above may be referred to as aerated nougat, which can include a coating to protect the integrity of the aerated nougat.

In some embodiments, the confection may include one or more confectionary fillings in addition to the nougat. Examples of materials suitable for use as the at least one other filling include, but are not limited to, fudge, candy floss (also known as cotton candy), ganache, meringue, marzipan, hard boiled candy, toffees, butterscotch, nut brittles or croquant, pralines or caramels, truffles, fourres, nut pastes, nut butters including peanut butter, coconut paste, creme paste, liquorice paste, chocolate spreads, chocolate crumb, nut butter, taffy, creme, mousse, nut butter, nut creme, fruit fillings, fondant including fondant-based cremes, frappe, fruit juice; vegetable juice; fruit puree; fruit pulp; vegetable pulp; vegetable puree; fruit sauce; vegetable sauce; honey; maple syrup; molasses; corn syrup; sugar syrup; liqueurs; chocolate syrup, dairy-based liquids such as milk, cream, or a combination of any number of these.

It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications be covered by the appended claims.

1. A plant-based nougat comprising potato protein isolate, a sugar syrup and a flavouring component.

2. The plant-based nougat according to claim 1, wherein at least 50 wt % of the potato protein isolate contain potato proteins having a molecular weight of less than 30 kDa, as measure by SDS-PAGE analysis.

3. The plant-based nougat according to claim 1, wherein at least 50 wt % of the potato protein isolate contain potato proteins having a molecular weight of 30 kDa or more, as measure by SDS-PAGE analysis.

4. The plant-based nougat according to claim 1, wherein the density of the plant-based nougat is 600-1100 kg/m³.

5. The plant-based nougat according to claim 1, wherein the plant-based nougat comprises 65-95 wt %, or 70-90 wt %, or 75-85 wt % sugar syrup.

6. The plant-based nougat according to claim 1, wherein the plant-based nougat comprises 0.5-20 wt %, or 1-15 wt %, or 2-10 wt % potato protein.

7. The plant-based nougat-food according to claim 1, wherein the flavouring component is selected from cocoa, honey, and a nut-derived component.

8. The plant-based nougat according to claim 1, wherein the plant-based nougat comprises 1-20 wt %, or 3-15 wt %, or 5-10 wt % nut butter as a flavouring component.

9. The plant-based nougat according to claim 1, wherein the plant-based nougat comprises nut inclusions, optionally wherein the plant-based nougat comprises 1-20 wt %, or 3-15 wt %, or 5-10 wt % nut inclusions as a flavouring component.

10. A method of producing a plant-based nougat, the method comprising:
aerating a whip solution comprising potato protein isolate, wherein a sugar syrup is added to the whip solution before, during or after aerating the whip solution, to form a frappe; and
adding a flavouring component to the frappe to form the plant-based nougat.

11. A plant-based food product comprising:
a plant-based nougat comprising potato protein isolate, a sugar syrup and a flavouring component; and
a component selected from plant-based chocolate and plant-based caramel.

12. The plant-based food product according to claim 11, wherein the product comprises the plant-based chocolate and the plant-based caramel.

13. The plant-based food product according to claim 11, wherein the plant-based caramel comprises a plant-based milk, plant-based fat, and sugar syrup, optionally wherein the plant-based caramel comprises inclusions, optionally wherein the plant-based caramel comprises nuts, or comprises 25-55 wt % nuts, or 30-50 wt % nuts, or 35-45 wt % nuts.

14. The plant-based food product according to claim 11, which is in the form of a bar comprising a plant-based nougat layer and a plant-based caramel layer, optionally wherein the plant-based nougat and plant-based caramel layer are enrobed in the plant-based chocolate.

15. A method of producing a plant-based food product, the method comprising:
combining a plant-based nougat comprising potato protein isolate, a sugar syrup and a flavouring component, and a component selected from a plant-based caramel and a plant-based chocolate to form the plant-based food product.
